(19) United States
(12) Patent Application Publication
(10) Pub. No.: US 2018/0361887 A1
(43) Pub. Date: Dec. 20, 2018

(54) Car Seat Child Safety Alert Device

(71) Applicant: Paula Labelle, Coeur D Alene, ID (US)

(72) Inventor: Paula Labelle, Coeur D Alene, ID (US)

(21) Appl. No.: 15/622,079

(22) Filed: Jun. 14, 2017

(51) Int. Cl. B60N 2/26; B60N 2/00; G08B 21/22

(52) U.S. Cl. CPC B60N 2/26; G08B 21/24; G08B 21/22; B60N 2/002

(57) ABSTRACT

The current invention are a wireless sensor and app to alert a user if they are walking away from a vehicle in which they left a child in a car seat. A pressure pad sensor is triggered by the weight of a child. An attached transmitter wirelessly communicates to any wireless device with the app. If the receiving device leaves the range of transmission before the transmissions cease, an alarm will be triggered in the receiving device. This allows a user's smartphone to also serve as an alert when about to forget a child in a car. An additional, optional, heart rate and temperature monitor ankle strap would allow the user to monitor a child during long trips.

### CROSS-REFERENCES TO RELATED APPLICATIONS (IF ANY)

None.

### BACKGROUND

### 1. Field of the Invention

This invention relates to child sensors and particularly ones that are designed for use with a child car seat.

### 2. Description of Prior Art

Since the 1990s, experts have recommended that child car seats be placed only in the rear row of seats in a vehicle. Since that time, there has been an increase in child deaths due to parents forgetting a child in a car during errands. As there are many demands on a parent, there are numerous potential causes for these distractions.

In the current art, there are some options to help reduce the occurrence of a child being left in a car. Recent technology provides for opportunities to produce mass market sensors and wireless data streaming to commonly owned electronic devices, such as cell phones. Options include a chest clip that signals when a clip is still latched, a car seat monitor that goes under the car seat pad, baby alert distance monitors that go off if the parent goes beyond a certain distance while the child is buckled and a sensor pad that goes under the car seat padding.

None are easy and quick to use.

There is still room for improvement in the art.

### SUMMARY OF THE INVENTION

The current invention are a sensor and wireless transmitter that signal if a user has left a child in a car seat. There are multiple methods for how the sensor would be placed, as well as an optional heart rate monitor band.

The sensor is a pressure pad that sits between the car seat and the child. The sensor has a wire running to a wireless transmitter. When the child is sitting on the sensor, the wireless transmitter sends a signal to a paired device. When the child is no longer triggering the sensor, the wireless transmitter sends a different signal to indicate the child is no longer in the car seat.

A wireless capable device, such as a cell phone, would have an Alarm App installed and running in the background. The App would be initiated either by the user or by receiving data from the transmitter. The expected primary use of the product is an alarm to notify if a child is left in a car. This alarm will be triggered if the receiving device ceases to receive transmissions before having received the signal that the child was removed. A second type of alert would indicate the child is no longer in the car seat. This alert would happen when the pressure pad ceases to be triggered; this could be helpful in indicating either the child has been intentionally removed or that the child has removed itself from the car seat while the vehicle is in motion.

The pressure pad sensor and transmitter are intended to be used placed inside specially designed blankets or seat pads. The sensor and transmitter go in an opening, located in the middle of the blanket or pad, so the child will rest directly on the sensor. Alternatively, the sensor and transmitter can be placed directly on the car seat or under the car seat pad, if the user prefers or if the blanket or pad is being washed. These blankets or pads can come in a variety of designs, shapes, and colors.

An optional heart rate and temperature monitor ankle band can be included or later installed to the blanket or pad. The ankle band will have a hook and loop fastening system for easy placement around the child's leg. The band would hold an attached monitor against the child's skin. The use of an ankle location allows easy access even when winter cold requires an infant be heavily bundled with clothing. The monitor could attach to the transmitter directly or have a separate transmitter to wirelessly communicate.

### BRIEF DESCRIPTION OF THE DRAWINGS

Without restricting the full scope of this invention, the preferred form of this invention is illustrated in the following drawings:

FIG. 1 shows the pressure pad sensor, connecting wire, and wireless transmitter;

FIG. 2 shows a possible design of the pad to hold the sensor and transmitter, with a heart rate/temperature monitor band on the bear's right ankle;

FIG. 3 shows the back of the pad, with a zipper in the middle for installing and removing the sensor and transmitter; and

FIG. 4 shows the components of the design; and

FIG. 5 shows the sensor and transmitter communicating with a smart device.

### DESCRIPTION OF THE PREFERRED EMBODIMENT

The current invention is a device 1 with a sensor 10 and wireless transmitter 30 that signal if a user has left a child in a car seat. There are multiple methods for how the sensor would be placed, as well as an optional heart rate monitor band 70.

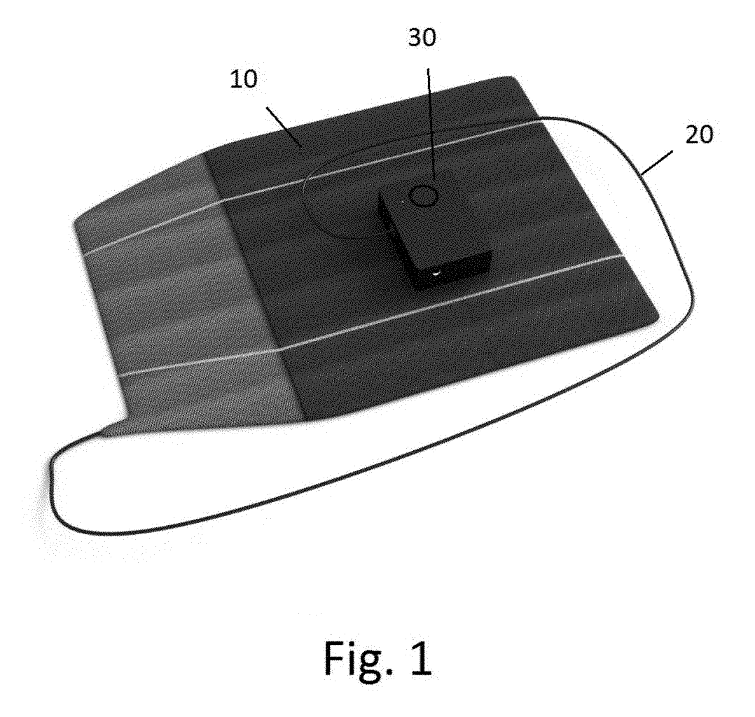

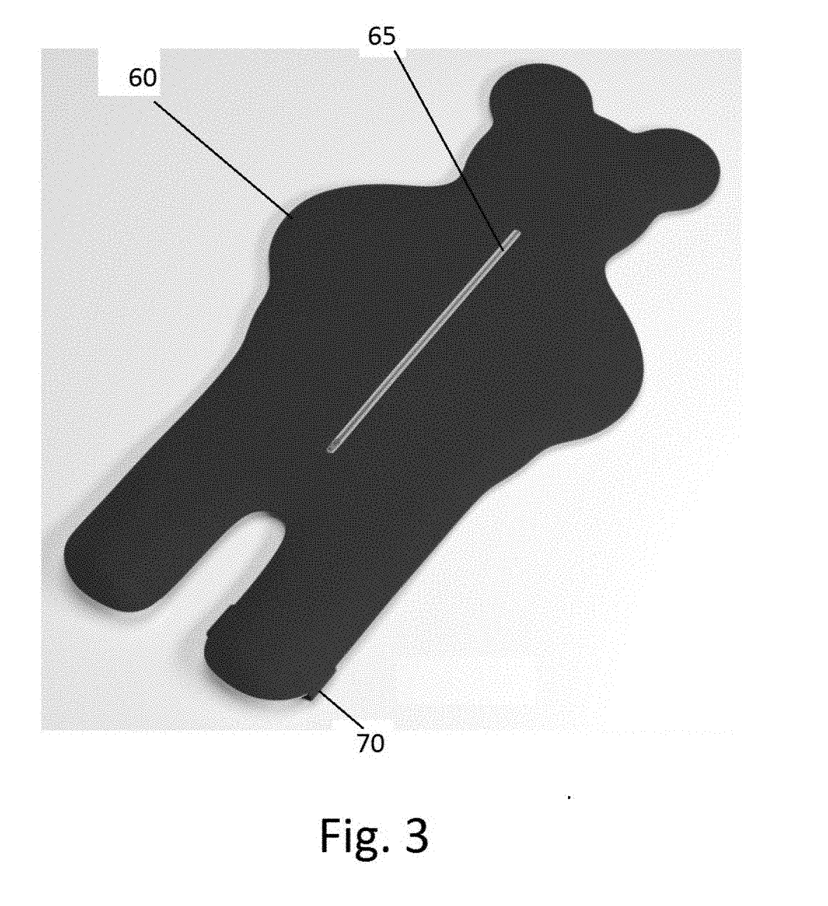

The device 1 is shown in FIGS. 1, 2 and 3. The sensor is a pressure pad 10 that sits between the car seat and the child. The sensor has a wire 20 running to a wireless transmitter 30. The wireless transmitter 30 can be placed at a convenient location near the car seat. When the child is sitting on the pressure pad 10 which reads weight on the pad 10, the wireless transmitter 30 sends a signal to a paired device 40 like a smartphone. When the child is no longer triggering the sensor, the wireless transmitter 30 sends a different signal to indicate the child is no longer in the car seat. The device 1 would have a power source which in the preferred embodiment would be batteries.

The paired device 40 is a wireless capable device, such as a cell phone or smartphone, would have an Alarm App installed and running in the background. The App would be initiated either by the user or by receiving data from the transmitter 30. The expected primary use of the current invention is as an alarm to notify if a child is left in a car. This alarm 50 will be triggered if the receiving paired device 40 ceases to receive transmissions before having received a signal that the child was removed. A second type of alert would indicate the child is no longer in the car seat. This alert would happen when the pressure pad ceases to be triggered; this could be helpful in indicating either the child has been intentionally removed or that the child has removed itself from the car seat while the vehicle is in motion.

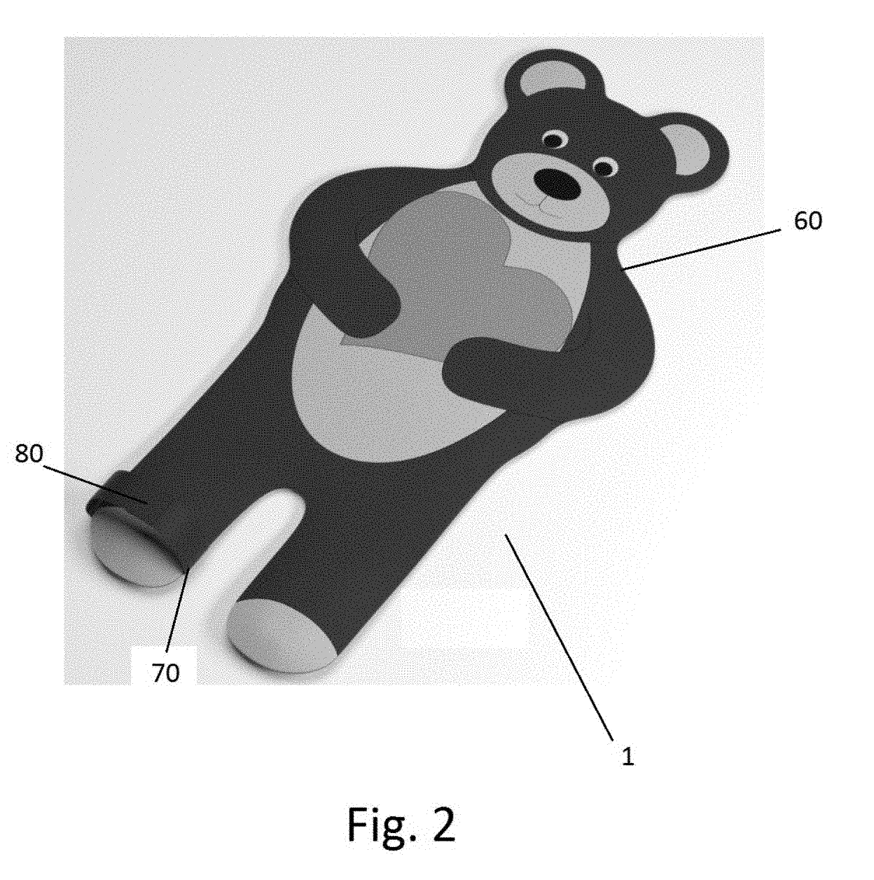

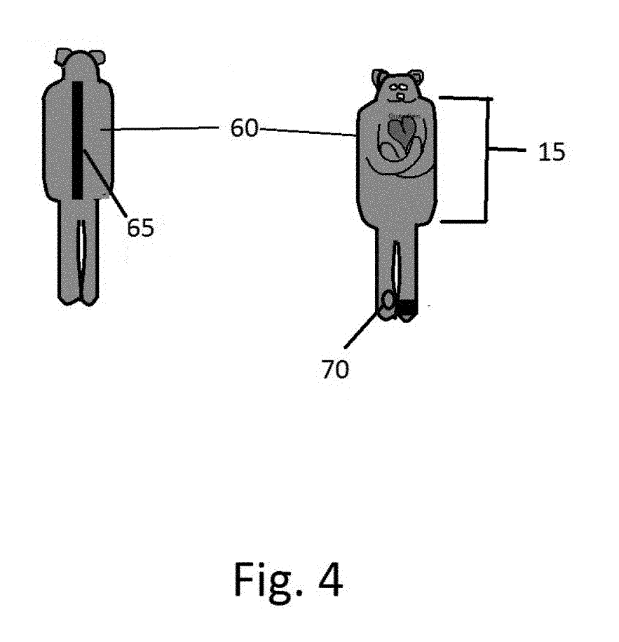

The pressure pad 10 sensor is, in the preferred embodiment, is placed inside specially designed blankets 60 or seat pads as shown in FIGS. 2, 3 and 4. The pressure pad 10 sensor will go in an opening 65 in the designed blankets 60, located in the middle of the blanket or pad, and placed in the pressure pad compartment 15 so the child will rest directly on the sensor. Alternatively, the pressure pad sensor 10 can be placed directly on the car seat or under the car seat pad, if the user prefers or if the blanket or pad is being washed. These blankets 60 or pads can come in a variety of designs, shapes, and colors.

An optional heart rate and temperature monitor ankle band can be included or later installed to the blanket 60 or pad. The ankle band 70 will have a hook and loop fastening system for easy placement around the child's leg. The band 70 would hold an attached monitor 80 against the child's skin. The use of an ankle location allows easy access even when winter cold requires an infant be heavily bundled with clothing. The monitor 80 could attach to the transmitter 30 directly or have a separate transmitter to wirelessly communicate.

As shown in FIGS. 2, 3 and 4, the blanket 60 or pad would have a cover in the shape of an animal that would fit into the car seat and the child would sit on it. Making it more attractive to a child to use.

The device 1, in the preferred embodiment, would have a heart monitor which would measure the heart rate of the child. The heart beat can be sent through the transmitter 30 to the paired device 40.

The device 1 can be used with any size car seat and can be switched from car seat to car seat. The sensor slides under the cushion of the car seat and is activated by weight.

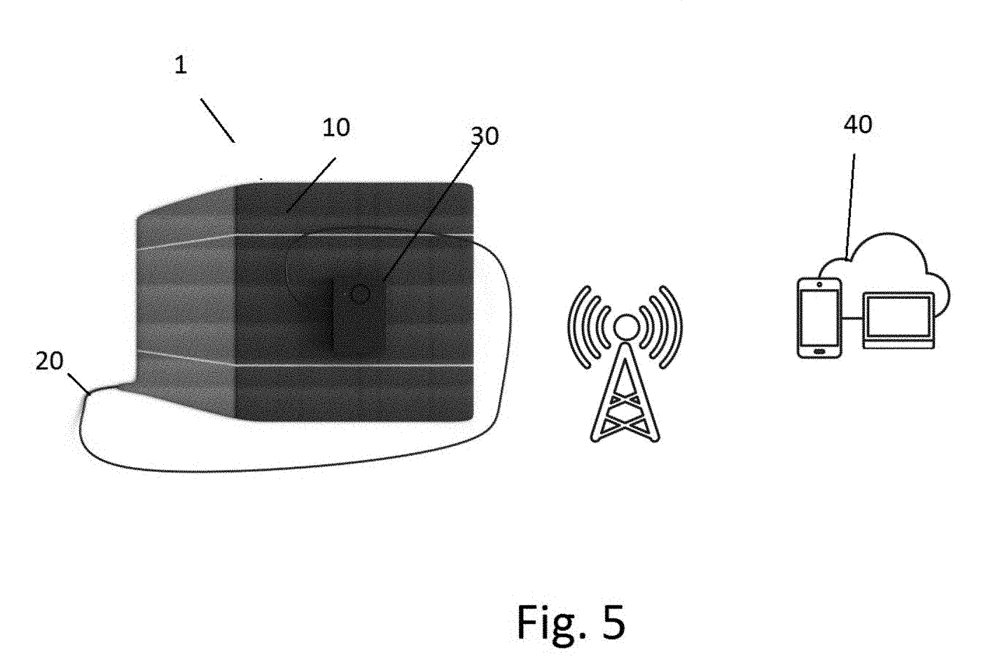

FIG. 5 shows the transmitter 30 communicating with the paired device 40. In the preferred embodiment, the paired device 40 will let out a will let out a loud tone, even if the paired device 40 is on silent mode.

The sensor will recognize when the user gets outside of the 15 foot safety perimeter and will activate the alarm if the pressure pad 10 reads that the child is still in the car seat and the paired device 40 is a certain distance away like 15 feet.

Advantages

In today's fast-paced world, it is easy to be forgetful. The Guardian Child Safety Seat makes it impossible to be forgetful of the most important aspect of your life, your child. The optional heart rate and temperature monitor is a feature that would be extremely beneficial if parents are taking young or sick children on longer trips.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A movable device to protect children from being left in a car seat comprising:
An alarm, a pressure pad sensor placed in a blanket connected to a transmitter and placing the sensor under a child in a car seat having an ankle band with a heart and temperature monitor having the heart and temperature monitor connect to the transmitter, having the transmitter send a transmission to a paired device when the pressure pad sensor reads that a child is in the seat and the paired device is a set distance away from the sensor and setting off the alarm.

2. A device according to claim 1 comprising:
Having the connection between the transmitter and the sensor be a wire.

3. (canceled)

4. (canceled)

5. (canceled)

6. (canceled)

7. (canceled)

8. (canceled)

9. (canceled)

10. A device according to claim 9 comprising:
Having the blanket have a unique design.

11. A device according to claim 10 comprising:
Placing the sensor in the blanket through an opening the sensor placed in a blanket.

12. A device according to claim 11 comprising:
Having the blanket having a sensor compartment.

13-20. (canceled)

21. A device according to claim 1 comprising:
the blanket having cover in the shape of an animal.

22. A device according to claim 1 comprising:
the paired device is a smart phone.

23. A device according to claim 1 comprising:
the alarm is in the paired device.

24. A device according to claim 22 comprising:
where the smart phone uses a computer application to read the transmission and set off the alarm.
